(19) United States
(12) Patent Application Publication
(10) Pub. No.: US 2011/0304275 A1
(43) Pub. Date: Dec. 15, 2011

(54) DISCHARGE LAMP LIGHTING DEVICE

(75) Inventors: Takumi Horikawa, Tokyo (JP); Akihiko Oohira, Tokyo (JP); Kikuro Sasayama, Tokyo (JP)

(73) Assignee: TDK-Lambda Corporation

(21) Appl. No.: 13/161,152

(22) Filed: Jun. 15, 2011

(30) Foreign Application Priority Data
Jun. 15, 2010 (JP) 2010-136459

(51) Int. Cl. H05B 41/18

(52) U.S. Cl. 315/224

(57) ABSTRACT

A discharge lamp lighting device capable of simply and inexpensively suppressing generation of unpleasant sounds from an inductive element is provided without increasing size. A discharge lamp lighting device includes a commutator 11 for supplying an AC current whose polarity alternately reverses to a discharge lamp 16, a high-voltage pulse transformer 35 capable of lighting the discharge lamp 16, a frequency varying means 48 for sequentially varying the frequency of a current supplied to the discharge lamp 16 with the discharge lamp 16 being kept lighted. Accordingly, with the discharge lamp 16 lighted, the frequency of the current supplied to the discharge lamp 16 is kept nonconstant and sequentially varied. Hence, the magnetic flux generated in a magnetic core 34 of the high-voltage pulse transformer 35 is prevented from being sequentially reversed in polarity at a constant frequency, thus effectively reducing the level of the unpleasant sounds.

### CROSS REFERENCE TO RELATED APPLICATIONS

This application claims the benefit of Japanese patent application Serial No. 2010-136459, entitled “DISCHARGE LAMP LIGHTING DEVICE”, filed Jun. 15, 2010, which is herein incorporated by reference in its entirety.

### BACKGROUND OF THE INVENTION

1. Field of the Invention

The present invention relates to a discharge lamp lighting device provided with an inductive element such as a high-voltage pulse transformer, a resonant inductor or the like, particularly to a discharge lamp lighting device capable of suppressing unpleasant high-pitched sounds generated from the inductive element.

2. Description of the Related Art

Generally, as this type of discharge lamp lighting device, Japanese unexamined patent application publication Nos. 2009-289684 and H8-330083, for example, disclose devices equipped with an inverter employing a plurality of switching elements and a starting circuit connected between the inverter and a discharge lamp as a load to cause the discharge lamp to light, in which the starting circuit is equipped with a high-voltage pulse transformer as a circuit component having an inductive element. According to the prior art, with a high-frequency AC power being output from the inverter, a high-voltage pulse is applied from the high-voltage pulse transformer to the discharge lamp to thereby start the discharge lamp, and after the discharge lamp has started, the discharge lamp can be continuously lighted by a low-frequency current supplied from the inverter circuit to the discharge lamp.

According to the discharge lamp lighting device configured as above, when the discharge lamp lighting device is in operation for lighting the discharge lamp, high-pitched unpleasant sounds often cause a problem as they are generated from the inductive element such as a high-voltage pulse transformer, a resonant inductor or the like.

Such unpleasant sounds are caused by the fact that the high-voltage pulse transformer to light the discharge lamp acts as an inductor after the lighting of the discharge lamp and therefore when the polarity of a current flowing through the discharge lamp is repeatedly reversed (commutated) within a frequency range of several tens to several hundreds of Hz, that of the magnetic flux generated in a magnetic core employed in the high-voltage pulse transformer is synchronously reversed with a current polarity change, so that the magnetostriction phenomenon occurs in the magnetic core to repeatedly expand and contract the magnetic core. Such a physical change gives rise to a resonant phenomenon with the structures including the high-voltage pulse transformer depending on the timing of the magnetic flux change of the magnetic core. The resonance propagates in the air to generate sounds, emitting the unpleasant sounds to humans in audible frequency bands ranging particularly from 10 kHz to 20 kHz.

In order to suppress such unpleasant sounds, the following techniques, for example, have heretofore been known. One is preventing the resonant phenomenon by fixing a magnetic core using a high-strength adhesive agent or by making up a high-voltage pulse transformer using an excessively large-sized magnetic core when assembling the core to make up the high-voltage pulse transformer. Another is preventing the phenomenon by housing the whole of a high-voltage pulse transformer within an enclosure such as a case and then filling the same with resin to fixedly cover the high-voltage pulse transformer so that no resonant phenomenon may occur.

According to the conventional techniques described above, fixing the magnetic core with an adhesive agent sometimes fails to achieve a sufficient effect due to variations in the fixing position of the magnetic core or in the amount of the adhesive agent used. Further, housing the whole of the high-voltage pulse transformer within the enclosure to fill resin therein may cause the problems of cost increase and at the same time lead to the discharge lamp lighting device being undesirably large-sized. In sum, even if any techniques are adopted, it is impossible to simply and inexpensively suppress generation of unpleasant sounds from the inductive element without increasing the size of device.

### SUMMARY OF THE INVENTION

Therefore, with the view of the problems described above, it is an object of the present invention to provide a discharge lamp lighting device capable of simply and inexpensively suppressing generation of unpleasant sounds from an inductive element without increasing the size.

In order to attain the object described above, there is provided a discharge lamp lighting device including an output circuit for supplying a current whose polarity alternately reverses to a discharge lamp, an inductive element connected between the output circuit and the discharge lamp to act as a starting circuit capable of lighting the discharge lamp, and a frequency varying means for sequentially varying a frequency of the current supplied to the discharge lamp with the discharge lamp being kept lighted.

Preferably, the frequency varying means may sequentially vary a frequency of the current within a range of ±10% with respect to a baseline frequency.

Further, the frequency varying means may regularly vary a frequency of the current.

Alternatively, the frequency varying means may randomly vary a frequency of the current.

Also, the frequency varying means may vary a frequency of the current either every one period or every half period.

Preferably, the discharge lamp lighting device may further include a control means for supplying a drive signal to the output circuit to control a period of polarity switching of the current, wherein the frequency varying means is incorporated into the control means to sequentially vary the period of polarity switching of the current.

Also, the discharge lamp lighting device may preferably further include a control means for supplying a drive signal to the output circuit to control a timing of polarity switching of the current, wherein the frequency varying means is connected between the control means and the output circuit to act as a delay circuit for delaying the drive signal while sequentially varying a delay time.

According to the present invention, since the frequency of the current applied to the discharge lamp is not kept constant but sequentially changed[varied] with the discharge lamp being allowed to be lighted, the magnetic flux generated in the inductive element can be prevented from being sequentially reversed in polarity at the same frequency, so that the level of unpleasant sounds generated from the inductive element can be effectively reduced. As a result, without bothering to take such a structural countermeasure using an adhesive agent and resin as was conventionally done, only by intentionally shifting the frequency of the current applied to the discharge lamp, the unpleasant sounds from the inductive element can be simply and inexpensively suppressed without increasing the size.

Further, by sequentially varying the frequency of the current applied to the discharge lamp within the range of ±10% of the baseline frequency, unpleasant sounds can be effectively prevented from being generated from the inductive element without needlessly changing the frequency of the current.

Furthermore, it becomes possible to regularly change the frequency of the current supplied to the discharge lamp.

Moreover, it becomes possible to randomly change the frequency of the current supplied to the discharge lamp using a random table or the like.

Also, it can be configured such that the current supplied to the discharge lamp may not be sequentially changed in polarity at the same frequency.

Further, by simply incorporating the program for sequentially changing the period of the polarity switching into the control means in addition to the program for determining the period of switching the polarity of the current supplied to the discharge lamp, unpleasant sounds can be effectively prevented from being generated from the inductive element.

Furthermore, even if the inside of the control means is not remodeled, unpleasant sounds can be effectively prevented from being generated from the inductive element only by adding a frequency changing means as a delay circuit to the outside of the control means.

### BRIEF DESCRIPTION OF THE DRAWINGS

These objects and other objects and advantages of the present invention will become more apparent upon reading of the following detailed description and the accompanying drawings in which:

FIG. 1 is a circuit diagram illustrating a configuration of a discharge lamp lighting device according to one embodiment of the present invention.

FIG. 2 is a graph showing measured data of sounds generated from a high-voltage pulse transformer in the circuit configuration in FIG. 1 according to the embodiment of the present invention.

FIG. 3 is another graph showing measured data of sounds generated from a high-voltage pulse transformer according to a conventional example.

### DETAILED DESCRIPTION OF THE INVENTION

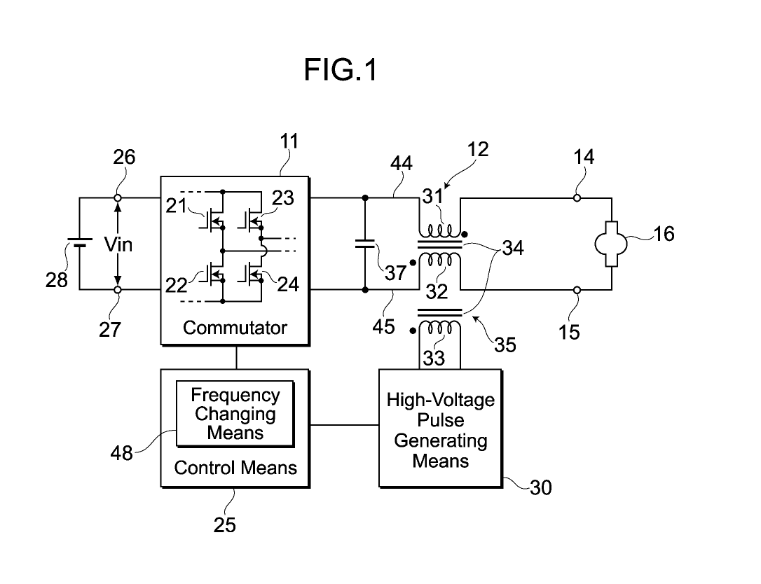

Hereunder is a description of a preferred embodiment according to the present invention with reference to accompanying drawings. FIG. 1 shows a circuit configuration of a discharge lamp lighting device in the present embodiment. In FIG. 1, numeral symbol 11 denotes a commutator for commutating of a polarity of a DC voltage (DC current). A discharge lamp 16 acting as a load is connected across the output terminals 14, 15 of the starting circuit 12, eventually the output terminals 14, 15 of the discharge lamp lighting device. The commutator 11 is made up of, e.g., four switching elements 21 to 24 that are full-bridge-connected with one another. A pulse drive signal is applied from a control means 25 to each of the four switching elements 21 to 24 and thus a DC input voltage Vin, which is applied from input terminals 26, 27 to the commutator 11 and is a DC voltage of, e.g., about 400V output from a DC power source 28, is commutated by the commutator 11 and is applied to the discharge lamp 16 through the starting circuit 12. A polarity of an output voltage applied to the discharge lamp 16 is alternately switched between positive and negative polarities. Additionally, the switching elements 21 to 24 may be substituted by a variety of semiconductor elements such as IGBTs or the like in addition to MOSFETs.

The starting circuit 12 receives a pulse start signal from a high-voltage pulse generating means 30 to generate and output a high voltage pulse capable of starting the discharge lamp 16 across the output terminals 14, 15 as an output voltage Vout. Here, the starting circuit 12 comprises a high-voltage pulse transformer 35 made up by winding two substantially equivalent first and second windings 31, 32 and a third winding 33, connected with an output end of the high-voltage pulse generating means 30, around a common magnetic core 34, and a capacitor 37 connected in series with the windings 31, 32 on an output side of the commutator 11. The winding 31 is connected with the intermediary portion of a first polarity line 44 extending from one output end of the commutator 11 to the output terminal 14 and the dot terminal, being one end of the winding 31, is connected with the output terminal 14 and further the no-dot terminal, being the other end of the winding 31, is connected with the one output end of the commutator 11. Further, the winding 32 is connected with the intermediary portion of a second polarity line 45 extending from the other output end of the commutator 11 to the output terminal 15 and the dot terminal, being one end of the winding 32, is connected with the other output end of the commutator 11 and further the no-dot terminal, being the other end of the winding 32, is connected with the output terminal 15. Furthermore, the capacitor 37 is connected between the no-dot terminal of the winding 31 and the dot terminal of the winding 32.

When a control signal is output from the control means 25 at the start of the discharge lamp 16, the high-voltage pulse generating means 30 (so-called “igniter”) supplies a pulse start signal to the winding 33 for a given length of time to thereby allow a high-voltage pulse voltage to be generated in the additive polarity windings 31, 32. Here, the discharge lamp 16 is connected with a series circuit of the windings 31, 32 and the capacitor 37. Therefore, the high-voltage pulse voltage induced in the windings 31, 32 is superimposed upon a voltage output from the commutator 11 and is applied to the discharge lamp 16, thus causing breakdown in the discharge lamp 16 to start the discharge lamp 16.

The control means 25 functions not only to output a control signal to the high-voltage pulse generating means 30 but also to output a pulse drive signal to the switching elements 21 to 24 in the commutator 11. Here, at the start of the discharge lamp 16 and at the steady state subsequent to the starting and lighting of the discharge lamp 16, the pulse drive signal is supplied from the control means 25 to the switching elements 21 to 24. Then, a pair of the switching elements 21, 24 and a pair of the switching elements 22, 23 alternately turn on and off at a high-frequency or a low-frequency to supply, to the discharge lamp 16, a current whose polarity reverses alternately between positive and negative at a high-frequency or a low-frequency.

According to the present embodiment, a current detector, not shown, detects a current flowing through the discharge lamp 16 at the steady state and the control means 25 properly controls electric power output from an electric power control means, not shown, connected between the electric power supply 28 and the commutator 11 so that the detected value becomes a target value, and at the same time the control means 25 supplies the pulse drive signal with respect to a baseline frequency fo (several tens to several hundreds of Hz) to each of the switching elements 21 to 24 in the commutator 11.

Further, according to the present embodiment, there is provided a frequency varying means 48 for sequentially (at every certain period) and intentionally varying the frequency of the pulse drive signal supplied to the commutator 11 and eventually a commutation frequency of a current supplied to the discharge lamp 16, preferably within a range of ±10% with respect to the baseline frequency fo determined by the control means 25.

Next is a description of a specific example of the frequency varying means 48 of the invention. In most discharge lamp lighting devices, the period for switching (commutating) the polarity of the current supplied to the discharge lamp 16 is controlled by the control means 25 composed of a microcomputer. Accordingly, when determining the period of polarity switching according to the program stored in the control means 25, there can be added to the program stored in the control means 25 a procedure for intentionally and sequentially changing the period of polarity switching (commutating), as the frequency changing means 48. Here, the frequency varying means 48 may determine the commutation frequency to be regularly varied with a constant period within a range of about ±10% of the baseline frequency fo, or determine the commutation frequency to be randomly varied using a random table so that it may be within a predetermined range of frequency. Alternatively, even if the control means 25 is not composed of the microcomputer having the aforementioned program, there may be equipped a delay circuit, serving as the frequency varying means 48, between the control circuit 25 and the commutator 11, in which the delay circuit sequentially varies and delays the pulse drive signal for the sake of changing the period of polarity switching of the current supplied to the discharge lamp 16 when the pulse drive signal is supplied to the switching elements 21 to 24.

Next, the operation of the aforementioned configuration is described hereunder. At the start of the discharge lamp 16, the pulse drive signal is supplied from the control means 25 to the switching elements 21 to 24 of the commutator 11, so that a pair of the switching elements 21, 24 and a pair of the switching elements 22, 23 alternately turn on and off, thus allowing a current commutating at high-frequency, output from the commutator 11, to be supplied to the starting circuit 12. Further, the control signal is supplied to the high-voltage pulse generator 30 from the control means 25, thus allowing the pulse drive signal to be outputted from the high-voltage pulse generator 30 to the winding 33 for the given length of time. In this way, a high-voltage pulse voltage induced in the windings 31, 32 is applied to the discharge lamp 16, as being superimposed upon a voltage output from the commutator 11, thus causing a breakdown in the discharge lamp 16 and starting the same accordingly.

Making the transition to the steady state of the discharge lamp 16 after starting and lighting thereof, the control means 25 then serves to control the power controlling unit (not shown) and determine the baseline frequency fo of the pulse drive signal supplied to the switching elements 21 to 24 of the commutator 11, and eventually of commutation of the current supplied to the discharge lamp 16 so that a detected value of the current flowing through the discharge lamp 16 becomes a given target value. The frequency varying means 48 serves to vary the frequency of the pulse drive signal preferably within the range of ±10% with respect to such baseline frequency fo so that the period for reversing (commutating) the polarity of the current supplied to the discharge lamp 16 is intentionally and sequentially changed. In this way, a current whose commutation frequency is sequentially varied is supplied to the discharge lamp 16 from the commutator 11 through the starting circuit 12, thereby allowing the discharge lamp 16 to be continuously lighted, so that the resonant phenomenon with a structure (not shown) including the high-voltage pulse transformer 35 that may occur depending on the timing of the polarity change of the magnetic flux in the magnetic core 34 of the high-voltage pulse transformer 35 can be restrained, and unpleasant sounds to humans can be eliminated particularly in the audible frequency range of 10 kHz to 20 kHz.

For example, assuming that the baseline frequency fo determined by the control means 25 is 100 Hz, the frequency varying means 48 serves to vary the frequency of the pulse drive signal supplied to the switching elements 21 to 24 within a range of ±3% (97 Hz to 103 Hz) with respect to this baseline frequency fo so that the frequency of the pulse drive signal varies through five to seven stages (steps) in each period. However, the frequency of the pulse drive signal is varied in sequence every one period (cycle) or every half period (cycle) so that the current supplied to the discharge lamp 16 is not sequentially switched in polarity at the same frequency, thereby more effectively dispersing the level of the unpleasant sound from the transformer 35 into a lower one.

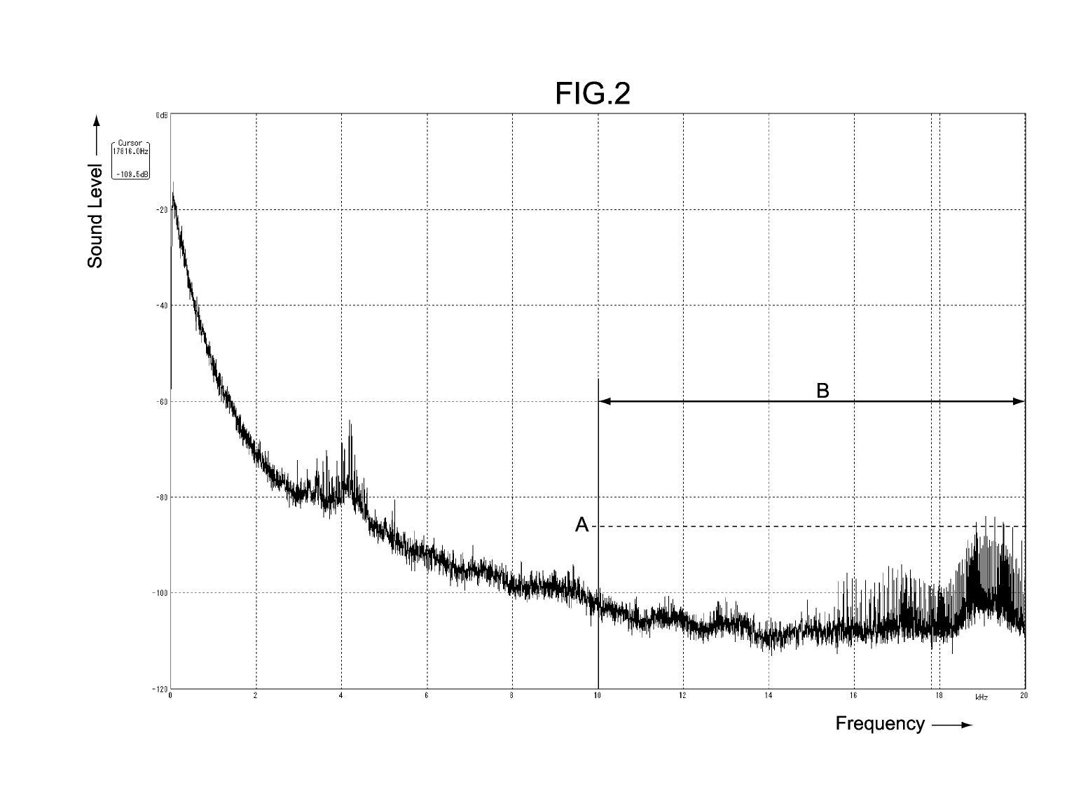

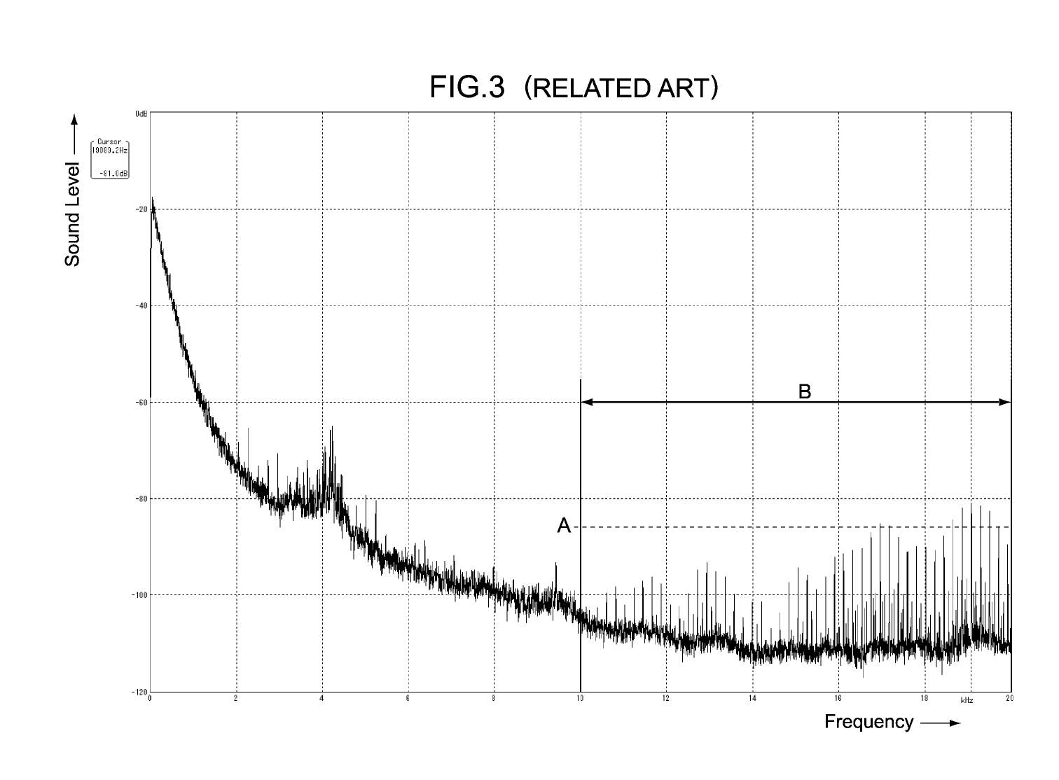

FIG. 2 shows a measurement data obtained by experimentally measuring the sounds generated from the high-voltage pulse transformer 35 in the circuit configuration proposed by the present embodiment shown in FIG. 1. In FIG. 2, a horizontal axis represents frequency (kHz), while a vertical axis represents sound level (dB). According to the experiment from which the aforementioned data was obtained, the commutation frequency of the current supplied to the discharge lamp 16 was repeatedly swept upward and downward within the range of upper and lower limits centered on the baseline frequency fo. Further, for the sake of comparison, FIG. 3 shows a data obtained by measuring a sound from one conventional device in which the commutation frequency of the current supplied to the discharge lamp 16 was not varied.

In FIG. 2 and FIG. 3, particularly referring to a frequency range B (10 kHz to 20 kHz) with which humans feel unpleasant, it was learnt that the conventional device shown in FIG. 3 generated high-level sounds with the integral-multiples of the baseline frequency fo due to the resonance between the magnetostriction phenomenon resulting from the magnetic flux change of the magnetic core 34 and the structure of the high-voltage pulse transformer 35 when the current was switched since the current whose commutation frequency is fixed baseline frequency flows through the windings 31, 32 of the high-voltage pulse transformer 35. Further, assuming that a sound level A with which humans feel unpleasant is −85 dB or more, it was learnt that the aforementioned high-level sounds with the integral-multiples of the baseline frequency fo reached around this sound level A.

On the other hand, the device of the present embodiment shown in FIG. 2 does not generate any high-level sounds, as generated by the conventional device, every integral-multiple of the baseline frequency fo, due to the effect that the device of the present embodiment sequentially varies the commutation frequency of the current supplied to the discharge lamp 16. As a result, the sounds generated by the device of the present embodiment does not reach the sound level A with which humans feel unpleasant, except for a significantly high frequency range in the frequency range B, thus effectively suppressing the generation of the unpleasant sounds. Further, the smaller the size of the high-voltage pulse transformer 35 is, the larger the unpleasant sounds become in general. Therefore, if the generation of the unpleasant sounds can be effectively suppressed in accordance with the present embodiment, it becomes possible to reduce the high-voltage pulse transformer 35 in size.

As described above, the discharge lamp lighting device of the present embodiment comprises the commutator 11 serving as an output circuit for supplying a current whose polarity alternately reverses to the discharge lamp 16, the high-voltage pulse transformer 35 as an inductive element connected between said output circuit and said discharge lamp to act as the starting circuit 12 capable of lighting said discharge lamp, and the frequency varying means 48 for sequentially varying the commutation frequency of the current supplied to the discharge lamp 16 with reference to the baseline frequency fo, determined by the control means 25, every one period (cycle) or every half period (cycle) in the steady state where the discharge lamp 16 is lighted.

Accordingly, when the discharge lamp 16 is being lighted, the commutation frequency of the current supplied to the discharge lamp 16 is kept nonconstant, but sequentially varied every one period (cycle) or every half period (cycle), thereby preventing the polarity of the magnetic flux generated in the magnetic core 34 of the high-voltage pulse transformer 35 from being repeatedly reversed at the same frequency, thus effectively reducing the sound level of the unpleasant sounds generated from the high-voltage pulse transformer 35. Therefore, the device of the present invention makes it possible to easily and inexpensively suppress the generation of the unpleasant sounds from the high-voltage pulse transformer 35 by only intentionally varying the commutation frequency of the current supplied to the discharge lamp 16, without intentionally implementing a structural countermeasure using an adhesive material and resin as was done conventionally, and enlarging the size of the device.

Specifically, the device of the present embodiment comprises the frequency varying means 48 for sequentially (i.e., every one period (cycle)) varying the commutation frequency of the current supplied to the discharge lamp 16 within the range of ±10% with respect to the baseline frequency fo. In this way, the commutation frequency of the current supplied to the discharge lamp 16 is sequentially varied within the range of ±10% with respect to the baseline frequency fo, thus effectively suppressing the generation of the unpleasant sounds from the high-voltage pulse transformer 35 without unduly varying the commutation frequency of the current.

Further, the frequency varying means 48 of the present embodiment regularly varies the commutation frequency of the current supplied to the discharge lamp 16.

Accordingly, it becomes possible to regularly vary the commutation frequency of the current supplied to the discharge lamp 16.

Furthermore, the frequency varying means 48 of the present embodiment randomly varies the commutation frequency of the current supplied to the discharge lamp 16.

Accordingly, it becomes possible to randomly vary the commutation frequency of the current supplied to the discharge lamp 16 using a random table.

Moreover, the frequency changing means 48 of the present embodiment changes the commutation frequency of the current every one period (cycle) or every half period (cycle).

Accordingly, it can be configured such that the current supplied to the discharge lamp 16 may not be sequentially changed in polarity at the same frequency.

Further, the frequency changing means 48 may be incorporated into the control means 25 so as to sequentially change the period of polarity switching of the current (so as to sequentially change the commutation frequency of the current) when determining the period of the polarity switching of the current supplied to the discharge lamp 16. As a result, the generation of the unpleasant sounds from the high-voltage transformer 35 can be effectively suppressed by simply incorporating the program for sequentially changing the period of the polarity switching into the control means 25 in addition to the program for determining the period of switching (commutating) the polarity of the current supplied to the discharge lamp 16.

Furthermore, as another example, the frequency varying means 48 is connected between the control means 25 and the commutator 11 in order to act as a delay circuit for delaying the pulse drive signal while sequentially varying a delay time (to which a delay time sequentially varying is caused) when the pulse drive signal is output from the control means 25 as a timing signal for switching (commutating) the polarity of the current supplied to the discharge lamp 16. In this way, even if the inside of the control means 25 cannot be remodeled, the unpleasant sounds from the high-voltage pulse transformer 35 can still be effectively suppressed by simply adding the frequency varying means 48 as the delay circuit to the outside of the control means 25.

However, the present invention is not limited to the present embodiment. As a matter of fact, various modified embodiments are possible within the scope of the gist of the present invention. For example, the commutator 11 serving as an output circuit is not limited to that of the full-bridge configuration of the present embodiment in which the four switching elements 21 to 24 are bridge connected to one another. Furthermore, other than the high-voltage pulse transformer 35 of the present embodiment, there can be used as an inductive element a resonant inductor formed by winding a single winding around a magnetic core.

What is claimed is:

1. A discharge lamp lighting device comprising:
an output circuit for supplying a current whose polarity alternately reverses to a discharge lamp;
an inductive element connected between said output circuit and said discharge lamp to act as a starting circuit capable of lighting said discharge lamp; and
a frequency varying means for sequentially varying a commutation frequency of the current supplied to said discharge lamp with said discharge lamp being kept lighted.

2. The discharge lamp lighting device according to claim 1, wherein said frequency varying means sequentially varies a commutation frequency of said current within a range of ±10% with respect to a baseline frequency.

3. The discharge lamp lighting device according to claim 2, wherein said frequency varying means regularly varies a commutation frequency of said current.

4. The discharge lamp lighting device according to claim 2, wherein said frequency varying means randomly varies a commutation frequency of said current.

5. The discharge lamp lighting device according to claim 2, wherein said frequency varying means varies a commutation frequency of said current either every one cycle or every half cycle.

6. The discharge lamp lighting device according to claim 1, further comprising:
a control means for supplying a drive signal to said output circuit to control a commutation frequency of said current,
wherein said frequency varying means is incorporated into said control means to sequentially vary a commutation frequency of said current.

7. The discharge lamp lighting device according to claim 2, further comprising;
a control means for supplying a drive signal to said output circuit to control a commutation frequency of said current,
wherein said frequency varying means is incorporated into said control means to sequentially vary a commutation frequency of said current.

8. The discharge lamp lighting device according to claim 1, further comprising:
a control means for supplying a drive signal to said output circuit to control a commutation timing of said current,
wherein said frequency varying means is connected between said control means and said output circuit to act as a delay circuit for delaying said drive signal while sequentially varying a delay time.

9. The discharge lamp lighting device according to claim 2, further comprising:
a control means for supplying a drive signal to said output circuit to control a commutation timing of said current,
wherein said frequency varying means is connected between said control means and said output circuit to act as a delay circuit for delaying said drive signal while sequentially varying a delay time.
